(19) United States
(12) Patent Application Publication
(10) Pub. No.: US 2016/0036136 A1
(43) Pub. Date: Feb. 4, 2016

(54) MULTIPLE POLARIZATION ELECTROMAGNETIC WAVE CIRCUITS AND METHODS

(71) Applicant: QUALCOMM Incorporated, San Diego, CA (US)

(72) Inventor: Saihua Lin, Santa Clara, CA (US)

(21) Appl. No.: 14/449,526

(22) Filed: Aug. 1, 2014

(51) Int. Cl. H01Q 21/24; H01Q 25/00; H04B 1/40; H01Q 21/00

(52) U.S. Cl. CPC H01Q 21/245; H01Q 21/0006; H01Q 25/00; H04B 1/40

(57) ABSTRACT

The present disclosure includes multiple polarization electromagnetic wave circuits and methods. In one embodiment, sensors are placed along different axes of an antenna. Sensors along an axis produce a differential signal when a wave on the antenna is polarized along the axis of the sensors. Sensors along another axis produce a common mode signal when a wave on the antenna is polarized along a different axis of the sensors. Another aspect of the disclosure includes a network of inductors arranged in a ring between a transceiver and a multiport antenna. Switches may be configured to couple ports of the antenna to ports of the transceiver to transmit and receive different polarizations.

### BACKGROUND

The present disclosure relates to electronic systems and methods, and in particular, to multiple polarization electromagnetic wave circuits and methods.

Antennas are often designed to receive particular polarizations of electromagnetic waves. For example, if a transmitting antenna produces a vertically polarized electromagnetic field (E-field) waveform, then the receiving antenna should also be vertically positioned to optimize reception of the wave. However, as a receiving antenna is rotated by an angle with respect to the incident E-field, polarization mismatch may occur. Antenna polarization mismatch can easily add on 10-20 dB loss in the communication channel when transmitting an orthogonally polarized wave between a transmitter and receiver pair.

FIG. 1 shows the effect of polarization mismatch. As an E-field incident on an antenna is shifted by an angle with respect to the polarization of the antenna, the reception of the E-field by the antenna will be reduced, resulting in loss. Some systems may use an antenna that can receive both vertical (V) and horizontal (H) polarizations with two output ports (one for each direction H and V) to limit the loss as shown in FIG. 1. However, losses for incident waves with large deviations from the expected orientation can still be problematic.

### SUMMARY

The present disclosure includes multiple polarization electromagnetic wave circuits and methods. In one embodiment, sensors are placed along different axes of an antenna. Sensors along an axis produce a differential signal when a wave on the antenna is polarized along the axis of the sensors. Sensors along another axis produce a common mode signal when a wave on the antenna is polarized along a different axis of the sensors. Another aspect of the disclosure includes a network of inductors arranged in a ring between a transceiver and a multiport antenna. Switches may be configured to couple ports of the antenna to ports of the transceiver to transmit and receive different polarizations. Embodiments disclosed herein may be used in wireless communication devices, for example.

The following detailed description and accompanying drawings provide a better understanding of the nature and advantages of the present disclosure.

### BRIEF DESCRIPTION OF THE DRAWINGS

FIG. 1 illustrates losses due to polarization mismatch.

FIG. 2 illustrates polarization sensing according to one embodiment.

FIG. 3 illustrates polarization sensing and path selection according to one embodiment.

FIG. 4 illustrates a multiple polarization interface according to one embodiment.

FIG. 5 illustrates a multiple polarization interface according to another embodiment.

FIG. 6 illustrates reception of a vertically polarized waveform on a first path according to one embodiment.

FIG. 7 illustrates reception of a horizontally polarized waveform on a second path according to one embodiment.

FIG. 8 illustrates transmission of a vertically polarized waveform on a first path according to one embodiment.

FIG. 9 illustrates transmission of a horizontally polarized waveform on a second path according to one embodiment.

FIG. 10A illustrates an example polarization detector circuit according to one embodiment.

FIG. 10B illustrates an example polarization detector circuit according to another embodiment.

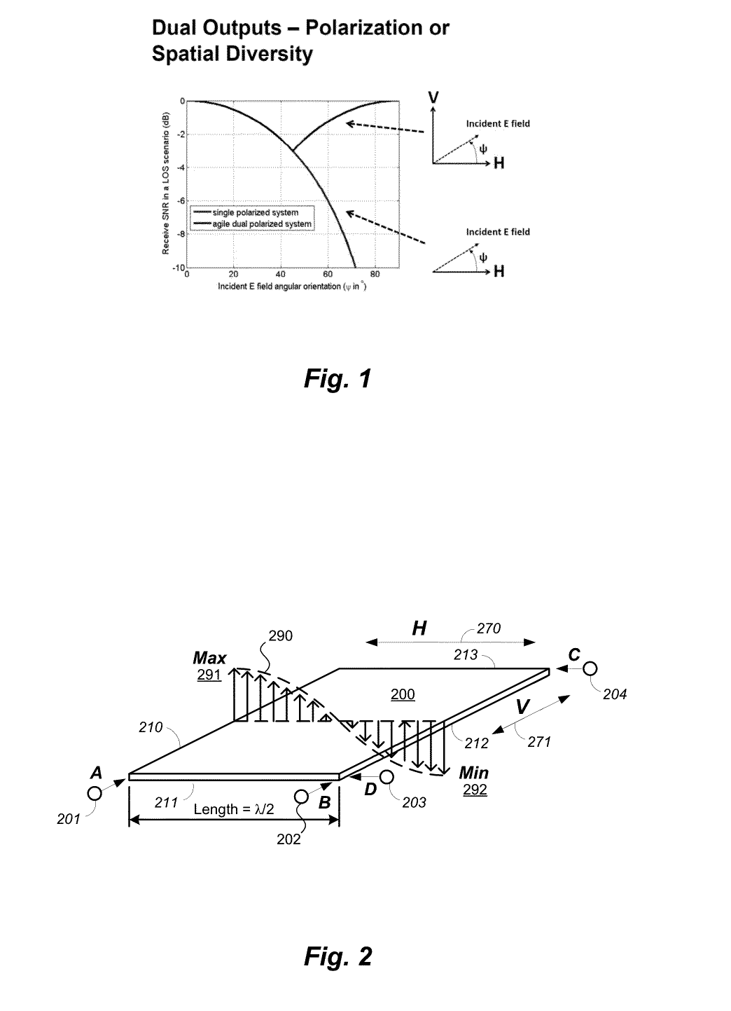

### DETAILED DESCRIPTION

The present disclosure pertains to multiple polarization electromagnetic wave circuits and methods. Embodiments disclosed herein may be used in wireless communication devices. In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

FIG. 2 illustrates polarization sensing according to one embodiment. FIG. 2 illustrates an antenna 200 configured to receive different polarities of electromagnetic waves. In one embodiment, antenna 200 may be a dual fed antenna, such as a patch antenna as shown in this example. Antenna 200 may receive a vertically polarized wave or a horizontally polarized wave, for example, over the airwaves (inbound) or from a transmitter (outbound). A horizontally polarized wave 290 is shown here to illustrate the operation of this example embodiment. Horizontally polarized wave 290 may produce a maximum field strength (Max) 291 along edge 210 and a minimum field strength (Min) 292 along an opposite edge 212, for example. Over time, the maximum 291 and minimum 292 of horizontally polarized wave 290 may propagate in the horizontal direction illustrated at 270 (H), for example. In this example, the distance between edges 210 and 212 (e.g., the length of the antenna in the horizontal direction) is one-half the wavelength. Accordingly, the field strength at edges 210 and 212 will have the same magnitude and opposite polarity. Edges 211 and 213 may be configured in the same manner so that a vertically polarized wave received on antenna 200 in the vertical direction (V) 271 exhibits the same properties along edges 211 and 213.

Embodiments of the present disclosure include sensors configured sense field strength along different edges of an antenna. In one embodiment, outputs from the sensors may be used to detect a polarization of an electromagnetic wave on antenna 200. Some embodiments may configure different signal paths based on polarization. In this example, two sensors 201 and 202 are configured at different horizontal positions (e.g., A and B) and two sensors 203 and 204 are configured at different vertical positions (e.g., C and D). Sensors 201 and 202 sense horizontal field strength at different points along the horizontal axis, and may be positioned at points A and B on edge 211, for example. Sensors 203 and 204 sense vertical field strength at different points along the vertical axis, and may be positioned at points C and D on edge 212, for example.

For a horizontally polarized wave, sensors 201 and 202 may produce differential signals because a horizontally polarized waveform exhibits the same magnitude and opposite polarity along the horizontal axis as described above. Similarly, a vertically polarized wave, sensors 203 and 204 may produce differential signals because a vertically polarized waveform exhibits the same magnitude and opposite polarity along the vertical axis. The pairs of sensors 201/202 and 203/204 may be separated by one-half a wavelength of the signal to be detected for maximum deviations of the differential signals, for example. As stated above, the pairs of sensors may be positioned at edges of an antenna that one-half a wavelength in width and height, for example.

Furthermore, when one set of sensors is producing a differential signal, the other sensors are producing a common mode signal. For instance, horizontally polarized wave 290 exhibits the same field strength along the vertical axis. Therefore, sensors 203 and 204, which are configured to detect differences along the vertical axis for vertically polarized waves, produce the same output values for horizontally polarized waves. In other words, the output of sensors 203 and 204 is a common mode signal when a horizontally polarized wave is received by antenna 200. Similarly, a vertically polarized wave exhibits the same field strength along the horizontal axis. Therefore, sensors 201 and 202, which are configured to detect differences along the horizontal axis for horizontally polarized waves, produce the same output values for vertically polarized waves. In other words, the output of sensors 201 and 202 is a common mode signal when a vertically polarized wave is received by antenna 200. A variety of techniques may be used to sense electromagnetic fields on an antenna. For example, in one embodiment, sensors 210-204 may comprise metal probes placed close to the edges of the antenna, where field strength is sensed utilizing capacitive coupling.

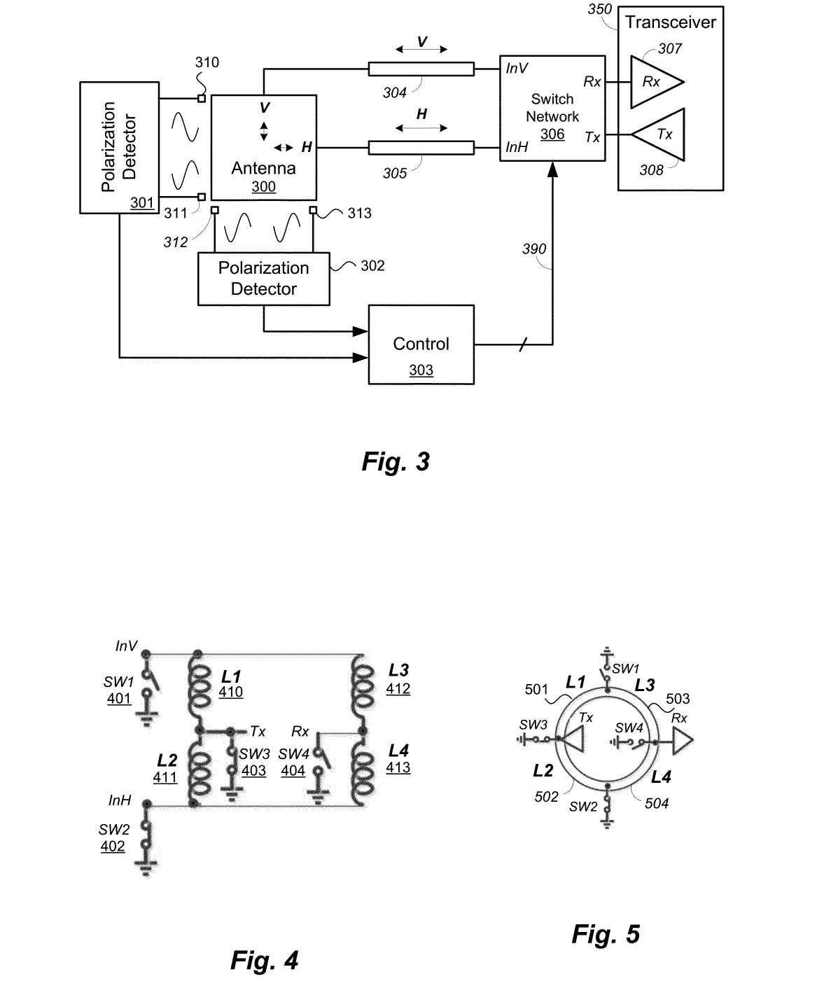

FIG. 3 illustrates polarization sensing and path selection according to one embodiment. In this example, a square patch antenna 300 may be used to send or receive horizontally or vertically polarized fields from a transceiver 350. The fields may be sensed by sensors 310-313 as described above. Sensors 310 and 311 are coupled to inputs of a polarization detector 301, and sensors 312 and 313 are coupled to inputs of a polarization detector 302. A horizontally polarized field on antenna 300 may produce a differential signal between sensors 312 and 313 and a common mode signal between sensors 310 and 311. Similarly, a vertically polarized field on antenna 300 may produce a differential signal between sensors 310 and 311 and a common mode signal between sensors 312 and 313. A differential signal across the inputs of a polarization detector 302 may be used to indicate that the field is horizontally polarized. Similarly, a differential signal across the inputs of a polarization detector 301 may be used to indicate that the field is vertically polarized.

Features and advantages of the present disclosure further include configuring a signal path between an antenna and a transceiver based on a detected polarization. For example, outputs of polarization detectors 301 and 302 may be coupled to a control circuit 303 to configure alternative pathways between antenna 300 and a receiver (Rx) 307 or a transmitter (Tx) 308 in transceiver 350. In one embodiment, when horizontal polarization is detected by polarization detector 302, a transceiver 350 is coupled to antenna 300 through a first signal path 305, and when a vertical polarization is detected by polarization detector 301, transceiver 350 is coupled to antenna 300 through a second signal path 304. Signal path 305 may be coupled to the antenna along the horizontal axis on a horizontal polarization port, for example, and signal path 304 may be coupled to antenna 300 along the vertical axis on a vertical polarization port. In one embodiment, signal path 304 and signal path 305 are quarter-wavelength transmission lines, for example.

Signal paths 304 and 305 are coupled to ports InV and InH of a multiple polarization interface (e.g., a “switch network”) 306. Multiple polarization interface 306 further includes ports Rx and Tx coupled to an input of a receiver 307 and to an output of transmitter 308, respectively. Switch network 306 may receive control signals 390 from control circuit 303 to configure pathways between antenna 300 and transceiver input/output Rx/Tx, for example. When a horizontally polarized waveform is detected during a receive mode, for example, control circuit 303 may configure switch network 306 to couple a signal received on port InH via signal path 305 to an input of receiver 307, for example. Similarly, when a vertically polarized waveform is detected during a receive mode, for example, control circuit 303 may configure switch network 306 to couple a signal received on port InV via signal path 304 to an input of receiver 307, for example. Alternatively, control circuit 303 may configure switch network 306 to couple a signal from transmitter 308 to port InV and signal path 304 for vertical polarization transmission on antenna 300. Likewise, control circuit 303 may configure switch network 306 to couple a signal from transmitter 308 to port InH and signal path 305 for horizontal polarization transmission on antenna 300. Example embodiments of multiple polarization interfaces are illustrated herein.

FIG. 4 illustrates a multiple polarization interface according to one embodiment. Another aspect of the present disclosure advantageously includes a ring of inductors to selectively couple a first signal path and a second signal path to a receiver input and transmitter output. A multiport inductor ring may advantageously couple ports of a dual polarization antenna with ports of a transceiver, for example. In this example, an interface may include inductors L1-L4 410-413. Inductor L1 410 has a first terminal coupled to a first signal path (input InV) and a second terminal coupled to an output of a transmitter (Tx). Inductor L2 411 has a first terminal coupled to a second signal path (input InH) and a second terminal coupled to the output of the transmitter (Tx). Similarly, inductor L3 412 has a first terminal coupled to the first signal path (input InV) and a second terminal coupled to an input of a receiver (Rx). Inductor L4 413 has a first terminal coupled to the second signal path (input InH) and a second terminal coupled to the input of the receiver (Rx). The inductors in this example form a ring because the first terminal of L1 is coupled to the first terminal of L3, the second terminal of L1 is coupled to the second terminal of L2, the first terminal of L2 is coupled to the first terminal of L4, and the second terminal of L4 is coupled to the second terminal of L3.

In this example, the inductors are selectively coupled to different paths using switches SW1-SW4 401-401. For instance, when SW1 is open and SW2 is closed, the transmitter or receiver may be coupled to the first signal path (e.g., on input InV). Similarly, when SW2 is open and SW1 is closed, the transmitter or receiver may be coupled to the second signal path (e.g., on input InH). The transmit and receive ports may similarly be selected using switches SW3 and SW4. For example, when SW3 is open and SW4 is closed, the transmitter may be coupled to ports InV or InH. Similarly, when SW4 is open and SW3 is closed, the receiver may be coupled to ports InV or InH.

FIG. 5 illustrates a multiple polarization interface according to another embodiment. In this example implementation, an inductor ring may be implemented as conductive trace forming a ring, such as a loop or circle, for example. In particular embodiments, terminals of different inductors in the ring may be nodes located around the ring. In one embodiment, the conductive trace is circular, and a first terminal and a second terminal of each inductor is separated by a 90 degree arc of the circular conductive trace, for example. It is to be understood that other shapes may be used and additional ports may be added with additional nodes in other applications. Inductances of each inductor in the ring may be changed by changing the length of the arc, for example, but in this example the inductors are substantially equal inductance. In particular, inductor L1 may be implemented along a 90 degree arc 501 of a circular conductive trace between a Tx node (at a terminal of SW3) and a node at a terminal of switch SW1. Inductor L2 may be implemented along a 90 degree arc 502 of a circular conductive trace between the Tx node (at a terminal of SW3) and a node at a terminal of switch SW2. Inductor L3 may be implemented along a 90 degree arc 503 of a circular conductive trace between an Rx input node (at a terminal of SW4) and a node at a terminal of switch SW1. Inductor L4 may be implemented along a 90 degree arc 504 of a circular conductive trace between the Rx input node (at a terminal of SW4) and a node at a terminal of switch SW2. A first path to/from an antenna may be coupled to the node at the terminal of switch SW1 and a second path to/from the antenna may be coupled to the node at the terminal of switch SW2, for example, to selectively receive or transmit different polarizations on the antenna.

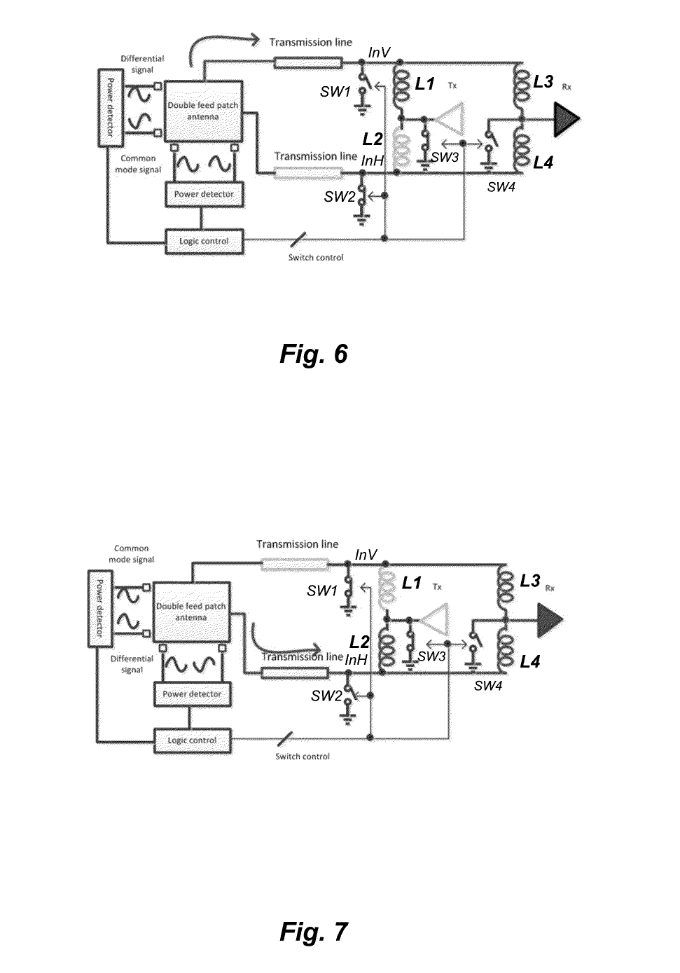

FIG. 6 illustrates reception of a vertically polarized waveform on a first path according to one embodiment. In this example, a double feed patch antenna is coupled to a transmitter (Tx) and receiver (Rx) over two transmission lines and a inductor ring interface. In FIG. 6, a vertically polarized waveform is detected on the antenna, and logic opens SW1 and SW4 and closes SW2 and SW3. Accordingly, InV at the terminal end of the vertical transmission line path is coupled to the input of Rx via series coupled inductors L3 and L4. L1 at InV is coupled to ground. Both terminals of L2 are coupled to ground.

FIG. 7 illustrates reception of a horizontally polarized waveform on a second path according to one embodiment. In this example, a horizontally polarized waveform is detected on the antenna, and logic opens SW2 and SW4 and closes SW1 and SW3. Accordingly, InH at the terminal end of the horizontal transmission line path is coupled to the input of Rx via series coupled inductors L4 and L3. L2 at InH is coupled to ground. In this case, both terminals of L1 are coupled to ground.

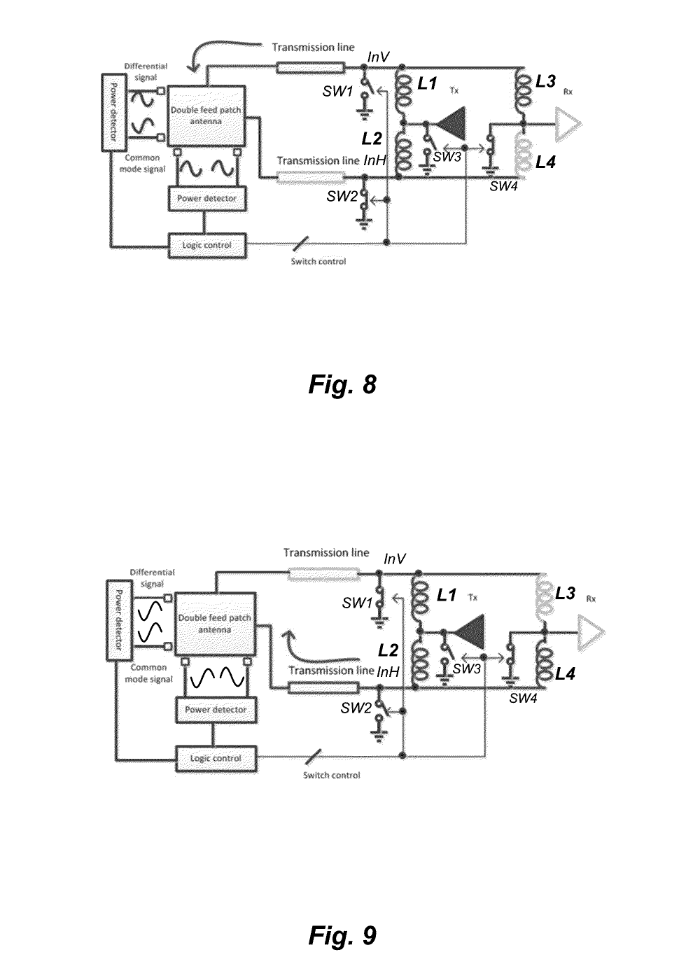

FIG. 8 illustrates transmission of a vertically polarized waveform on a first path according to one embodiment. In this example, a vertically polarized waveform is transmitted, and logic opens SW1 and SW3 and closes SW2 and SW4. Accordingly, InV at a terminal of the vertical transmission line path is coupled to the input of Tx via series coupled inductors L1 and L2. L3 at InV is coupled to ground. In this case, both terminals of L4 are coupled to ground.

FIG. 9 illustrates transmission of a horizontally polarized waveform on a second path according to one embodiment. In this example, a horizontally polarized waveform is transmitted, and logic opens SW2 and SW3 and closes SW1 and SW4. Accordingly, InH at a terminal of the horizontal transmission line path is coupled to the input of Tx via series coupled inductors L2 and L1. L4 at InH is coupled to ground. In this case, both terminals of L3 are coupled to ground.

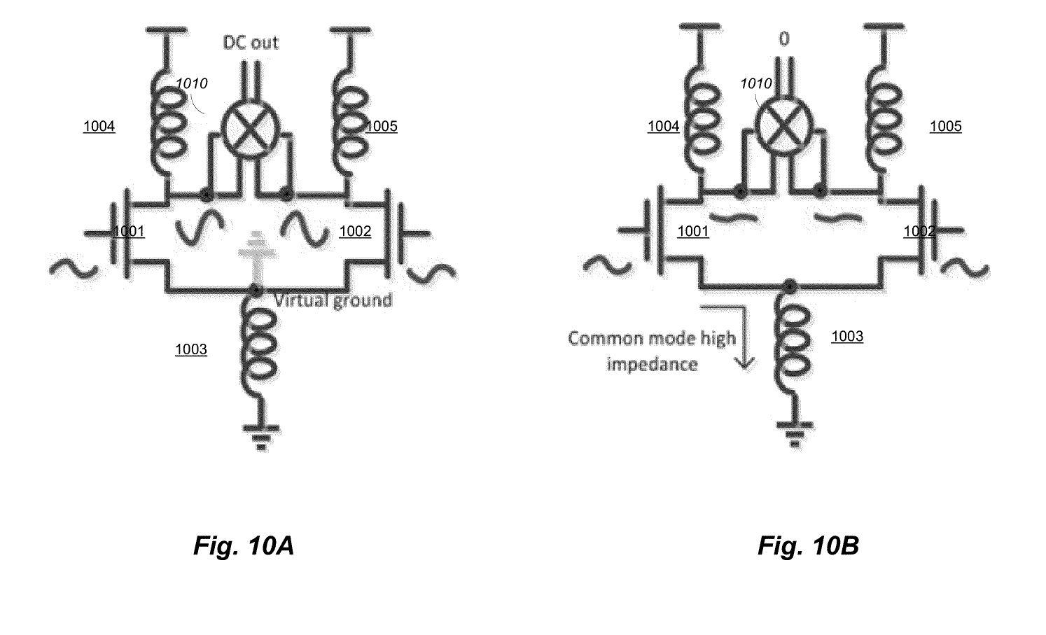

FIG. 10A illustrates an example polarization detector circuit according to one embodiment. In one example, polarization detectors may be implemented using differential amplifiers. Additionally, an output of a differential amplifier may be coupled to a mixer. For example, one sensor may be coupled to a control terminal of transistor 1001 and a second sensor configured to detect polarization along the same axis may be coupled to a control terminal of transistor 1002. Terminals (e.g., sources) of transistors 1001 and 1002 may be coupled to a reference voltage, such as ground, through an inductor 1003, for example. The other terminals (e.g., drains) of transistors 1001 and 1002 are coupled to a power supply voltage through inductors 1004 and 1005, respectively, and to inputs of mixer 1010. In this case shown in FIG. 10A, the circuit receives a differential signal from sensors (not shown). In this case, the source coupled node forms a virtual ground and the differential signal is amplified at the inputs of mixer 1001. Two inputs of mixer 1010 are coupled to one drain and the other two inputs of mixer 1010 are coupled to the other drain so that the mixer produces a DC voltage in response to the differential signal. FIG. 10B illustrates the operation of the circuit for a common mode input from antenna sensors (not shown). In this case, the source coupled node forms a high common mode impedance, and the common mode signal is rejected (attenuated) at the inputs of mixer 1010. Therefore, outputs of each mixer may be used to detect the polarization of an electromagnetic wave on the antenna. When the output of a mixer is a DC value greater than a threshold, for example, for a polarity detector having sensor inputs along a particular axis, then the circuit knows that the received wave is along that axis. Alternatively, when the output of a mixer is zero (or nearly zero), for example, for a polarity detector having sensor inputs along a particular axis, then the circuit knows that the received wave is not along that axis.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A wireless communication device comprising:
a first sensor configured to sense an electromagnetic field at a first position along a first axis of an antenna;
a second sensor configured to sense the electromagnetic field at a second position along the first axis of the antenna;
a third sensor configured to sense the electromagnetic field at a first position along a second axis of the antenna;
a fourth sensor configured to sense the electromagnetic field at a second position along the second axis of the antenna;
a first detector coupled to the first sensor and the second sensor, the first detector detecting a first polarization of the electromagnetic field; and
a second detector coupled to the third sensor and the fourth sensor, the second detector detecting a second polarization of the electromagnetic field.

2. The wireless communication device of claim 1 wherein the first polarization is a horizontal polarization and the second polarization is a vertical polarization.

3. The wireless communication device of claim 1 wherein the first polarization produces a first differential signal across the first sensor and the second sensor, wherein the second polarization produces a first common mode signal across the first sensor and the second sensor, wherein the second polarization produces a second differential signal across the third sensor and the fourth sensor, wherein the first polarization produces a second common mode signal across the third sensor and the fourth sensor.

4. The wireless communication device of claim 3, the first detector comprising a differential amplifier to amplify the first differential signal and attenuate the first common mode signal, and in accordance therewith, detect the first polarization.

5. The wireless communication device of claim 3, the second detector comprising a differential amplifier to amplify the second differential signal and attenuate the second common mode signal, and in accordance therewith, detect the second polarization.

6. The wireless communication device of claim 1 wherein when the first polarization is detected by the first detector, a transceiver is coupled to the antenna through a first signal path, and when the second polarization is detected by the second detector, the transceiver is coupled to the antenna through a second signal path.

7. The wireless communication device of claim 6 wherein the first signal path is coupled to the antenna along the first axis, and wherein the second signal path is coupled to the antenna along the second axis.

8. The wireless communication device of claim 6 wherein the first signal path and the second signal path are quarter-wavelength transmission lines.

9. The wireless communication device of claim 6 further comprising a ring of inductors to selectively couple the first signal path and the second signal path to a receiver input and transmitter output.

10. The wireless communication device of claim 9, the ring of inductors comprising:
a first inductor having a first terminal coupled to the first signal path and a second terminal coupled to a transmitter output;
a second inductor having a first terminal coupled to the second signal path and a second terminal coupled to the transmitter output;
a third inductor having a first terminal coupled to the first signal path and a second terminal coupled to a receiver input;
a fourth inductor having a first terminal coupled to the second signal path and a second terminal coupled to the receiver output.

11. The wireless communication device of claim 10 wherein the first inductor, the second inductor, the third inductor, and the fourth inductor comprise a circular conductive trace, and wherein first terminal and second terminal of each inductor is separated by a 90 degree arc of the circular conductive trace.

12. The wireless communication device of claim 10 further comprising:
a first switch coupled between the first terminal of the first inductor and a reference voltage;
a second switch coupled between the first terminal of the second inductor and the reference voltage;
a third switch coupled between the second terminal of the first inductor and the reference voltage; and
a fourth switch coupled between the second terminal of the third inductor and the reference voltage.

13. A method comprising:
sensing an electromagnetic field at a first position along a first axis of an antenna to produce a first sensor output;
sensing the electromagnetic field at a second position along the first axis of the antenna to produce a second sensor output;
sensing the electromagnetic field at a first position along a second axis of the antenna to produce a third sensor output;
sensing the electromagnetic field at a second position along the second axis of the antenna to produce a fourth sensor output;
detecting a first polarization of the electromagnetic field based on the first sensor output and the second sensor output; and
detecting a second polarization of the electromagnetic field based on the third sensor output and the fourth sensor output.

14. The method of claim 13 wherein the first polarization is a horizontal polarization and the second polarization is a vertical polarization.

15. The method of claim 13 wherein the first polarization produces a first differential signal between the first sensor output and the second sensor output, wherein the second polarization produces a first common mode signal between the first sensor output and the second sensor output, wherein the second polarization produces a second differential signal between the third sensor output and the fourth sensor output, wherein the first polarization produces a second common mode signal between the third sensor output and the fourth sensor output.

16. The method of claim 15 further comprising differentially amplifying the first and second differential signals and attenuating the first and second common mode signals, and in accordance therewith, detecting the first and second polarizations.

17. The method of claim 13 wherein when the first polarization is detected by the first detector, a transceiver is coupled to the antenna through a first signal path, and when the second polarization is detected by the second detector, the transceiver is coupled to the antenna through a second signal path.

18. A wireless communication device comprising:
a transmitter having an output;
a receiver having an input;
a first inductor having a first terminal coupled to the output of the transmitter and a second terminal coupled to a first input of an antenna through a first signal path;
a second inductor having a first terminal coupled to the output of the transmitter and a second terminal coupled to a second input of the antenna through a second signal path;
a third inductor having a first terminal coupled to the input of the receiver and a second terminal coupled to the first input of the antenna through the first signal path;
a fourth inductor having a first terminal coupled to the input of the receiver and a second terminal coupled to the second input of the antenna through the second signal path;
a first switch coupled between the second terminal of the first inductor and a reference voltage;
a second switch coupled between the second terminal of the second inductor and the reference voltage;
a third switch coupled between the output of the transmitter and the reference voltage; and
a fourth switch coupled between the input of the receiver and the reference voltage.

19. The wireless communication device of claim 18 further comprising a control circuit to configure the first switch, the second switch, the third switch, and the fourth switch,
wherein when a first waveform having a first polarization is detected on the antenna, the first switch and the fourth switch are opened, and the second switch and the third switch are closed,
wherein when a second waveform having a second polarization is detected on the antenna, the first switch and the fourth switch are closed, and the second switch and the third switch are opened,
wherein when a third waveform is to be transmitted with the first polarization, the first switch and the third switch are opened, and the second switch and the fourth switch are closed, and
wherein when a fourth waveform is to be transmitted with the second polarization, the second switch and the third switch are opened, and the first switch and the fourth switch are closed.

20. The wireless communication device of claim 18 wherein the first inductor, the second inductor, the third inductor, and the fourth inductor comprise a circular conductive trace, and wherein first terminal and second terminal of each inductor is separated by a 90 degree arc of the circular conductive trace.
